(19) United States
(12) Patent Application Publication
(10) Pub. No.: US 2021/0394688 A1
(43) Pub. Date: Dec. 23, 2021

(54) Headliner With Shaped Upper Edges For Fastening

(71) Applicant: Motus Integrated Technologies, Holland, MI (US)

(72) Inventor: Ralf Mailänder, Bettendorf (LU)

(21) Appl. No.: 17/353,551

(22) Filed: Jun. 21, 2021

Related U.S. Application Data
(60) Provisional application No. 63/041,607, filed on Jun. 19, 2020.

(51) Int. Cl. B60R 13/02

(52) U.S. Cl. CPC B60R 13/0231; B60R 13/0225

(57) ABSTRACT

The present embodiments include a headliner with a roof opening and methods for producing the headliner. In one embodiment, the headliner, which has a bent shape in an area of a sunroof opening, comprises a fold, the fold comprising a flange with a shape adjoins the fold, which enables pull-out installation of the headlining without the use of additional fasteners in the area of the sunroof opening.

### CROSS-REFERENCE TO RELATED APPLICATIONS

The present application is a Non-provisional application of U.S. Provisional Application No. 63/041,607, entitled “HEADLINER WITH SHAPED UPPER EDGES FOR FASTENING,” and filed Jun. 19, 2020, the entirety of which is incorporated by reference herein for all purposes.

The present application relates to headliners with one or more roof openings, a method for fastening headliners to a roof cassette, and methods for producing the headliners.

Vehicle cabs may include an overhead liner that may be used, for example, as a cover over the cab's roof, for aesthetic purposes, for insulation, and the like. Some vehicles may further include a roof opening, having a roof cassette, e.g., a sunroof, which may be used, for example, to enable light to enter the cab. It would be beneficial to improve headliners that interface with roof cassettes.

### BRIEF DESCRIPTION

Headliners may be cladding parts for vehicle roofs, which may come in a variety of different designs. For example, full-surface cladding designs on the inside of the roof may be referred to as a full roof or a “normal” roof lining. The market share of molded headliners that have one or more roof openings may be referred to as sunroofs or panoramic roofs. The market share of vehicles with large roof openings has been growing for a long time. The larger types of roof openings may have an area with an elevated shape directed away from the interior of the vehicle. This type of elevated shape may be followed by a fold.

A headliner may be firmly and/or permanently connected to the sliding roof cassette behind the headliner and may be aesthetically pleasing in the connection area. The techniques described herein enable for a headliner installation that may be more simple and effective to carry out. The techniques described herein may provide vehicle manufacturers, for example, with trim part(s) that may be assembled and disassembled several times, for example, ten times or more, without adverse effects.

The techniques described herein include, in certain embodiments, a headliner with a special edge formation in the so-called sunroof or panorama roof area. A fold on these headliners may be created via the headliner substrate, and fold may be at any angle to the raised shape to be used for permanent fastening of the headliner.

The development of electrically powered motor vehicles may require a larger amount of space for the storage batteries, which are usually housed in the vehicle's floor. The height of the interior should not be reduced due to the storage batteries. For example, headroom may improve occupant comfort. Automotive designers therefore may endeavor to reduce the installation space between the inner surface of the roof cladding part and the roof outer skin in order to obtain more storage space for batteries in the floor area with the same headroom and unchanged vehicle aerodynamics.

In certain embodiments, fastening techniques are described, which enable assembly without a so-called sunroof or reinforcement frame and may also include further design features which may be able to significantly reduce the installation space. These techniques may meet the requirements for simple and permanent installation as well as the requirement for multiple non-destructive removal and reinstallation.

Due to a tolerance chain that may result from individual components, an air gap to compensate for tolerances may be constructed in certain sunroof frames. The human eye may be sensitive to shape deviations along narrow gaps and a person may perceive these shape deviations. This perception issue may no longer exists using the techniques described herein.

The bending or forming process used herein may include a thermal-mechanical process. In a thermal-mechanical forming process described herein, the heated back of the substrate does not have to adhere to the back of an unheated substrate. In a thermal forming process described herein, a bending line is mainly heated (e.g., at higher heat values) so that a forming process along this edge (e.g., bending line) is performed and thus a plastic deformation of the edge area can take place. Accordingly, a permanently changed molded part contour may be achieved in the headliner. A form and/or a frictional engagement may be molded into the headliner or the substrate of the headliner before these areas are brought into their final position via the subsequent bending process.

The headliner may be trimmed at least in partial areas with length allowances for the folding before the folding process takes place and before these areas are brought into their desired position. Additionally, cost advantages may arise when a headliner is manufactured in a so-called one-step process and the folding edges are produced in a folding process. In the one-step process, the decor is already connected to the mold carrier, e.g., the substrate, in the molding process. Additionally and in certain embodiments, there is no pre-trimming before the lamination process and during the lamination process itself. Further, two cost-effective manufacturing processes may be used in combination for their respective functions, such as a folding process and a lamination process.

However, there may be restrictions on component design in a one-step part. Large shape distortions and tight radii may pose a problem for the molding process. However, incisions that are only to be present in the substrate, but not in the decor, and decor protrusions on the finished part, the length of the decor protruding beyond the boundary of the substrate, may also be reasons for producing a molded part in the so-called two-step process as opposed to the one-step process.

During the two-step process, you may first form the substrate without decor. Larger distortions and smaller radii may be molded more easily and cuts may be made in a first trimming process, the so-called pre-trimming, or trim edges may be created for a later decor protrusion. When using an airbag, incisions in the substrate at the corners of the holes for the handle attachment may be provided. After the pre-trimming on the mold carrier, the decor may laminated onto the carrier part in a laminating tool. This lamination may be followed by a final trimming, in which, in contrast to the pre-trimming, decor protrusions can may also be produced by a partially longer trimming. This final trimming procedure may be established for the preparation of the textile fold without a beam fold in the sunroof area and on the front and/or rear edge.

The two-step system may be combined with a thermal girder fold. Advantages of the two-step system with the use of the girder fold can lead to an improved technical and economic solution. In this combination, an aim would be to use the substrate properties to enable the sunroof frame-free assembly. The cost advantages of combining a two-step part with a girder fold may be lower than when using a single-step part, but may still be high compared to a two-step part with a sliding roof frame and a conventional decorative fold. However, advantages include a higher headroom due to the lower overall height, a higher quality impression in the transition from the headliner to the sunroof cassette, and the significantly lower overall weight.

Various other features, advantages, and objects of the present invention will be made apparent from the following detailed description and any appended drawings.

### BRIEF DESCRIPTION OF THE DRAWINGS

One or more preferred exemplary embodiments of the invention are illustrated in the accompanying drawings in which like reference numerals represent like parts throughout and in which:

FIG. 1 is a sectional view of an embodiment of a headliner disposed in a sunroof cassette;

FIG. 2 is another sectional view of an embodiment of a headliner disposed in a sunroof cassette;

FIG. 3 is yet another an embodiment of a headliner disposed in a sunroof cassette with a folding;

FIG. 4A is a sectional view of an embodiment of a headliner with a stop edge disposed in a sunroof cassette;

FIG. 4B is a sectional view of an embodiment of a molded headliner flange with conical embossing;

FIGS. 5A-5C are sectional views of an embodiment of a headliner with a stop edge disposed in a sunroof cassette;

FIG. 6 is a side view of embodiments of certain structures of FIG. 5C;

FIG. 7A is a side view of embodiments of a headliner being disposed in a sunroof cassette having a bow-like component;

FIG. 7B is a side view of embodiments of a headliner being disposed in a sunroof cassette having a slot-shaped receptacle;

FIG. 7C-7F are a side views of embodiments of a headliner being disposed in a sunroof cassette having a bevel-like component; and

FIG. 8 is a view of an embodiment of a two-component presser system.

### DETAILED DESCRIPTION

Design of the Headliner

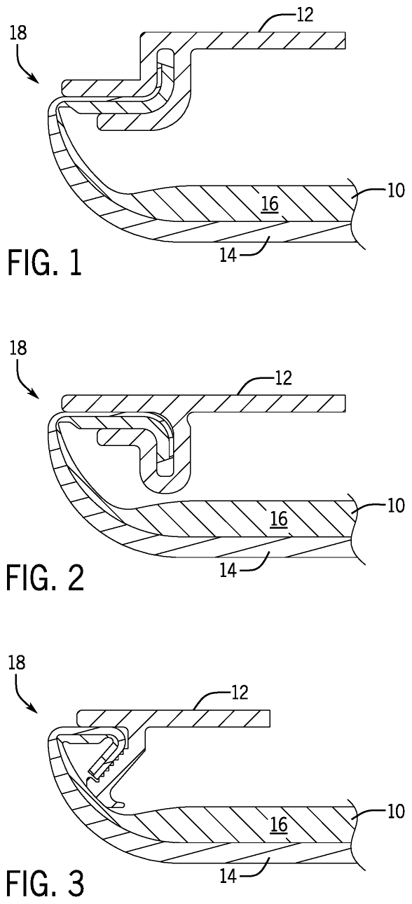

The techniques described herein may include a headliner which may include a flange-like edge all around in the area of the roof opening. The difference in this new headliner with previous headliners may include the shape in this border or edge. For example, the shape may have partial structures that enable more effective assembly of the headliner and at the same time prevent unwanted slipping out or pulling out when assembled. Depending on a version of a headliner, an embodiment can be selected in which a folded edge area is inserted into an end position by being pushed into a slot opening. (e.g., as further described with respect to FIGS. 1-4). A material tension in the folded edge area may cause a pressure force of the decorative side (e.g., side viewable from inside of a vehicle) against the receiving edge of the sunroof cassette. This pressure force or bias may create a more improved aesthetic transition from the décor (e.g., side viewable from inside of a vehicle) to the contact edge of the sunroof cassette. A clamping effect may also be achieved by an increasing material thickness or groove-shaped structures of the shaped sky substrate or suitable structures in the receiving profile.

Turning now to the figures, FIGS. 1-3 illustrates embodiments of a molded headliner 10 that is disposed in a sunroof cassette 12 (e.g., sliding roof cassette). The molded headliner 10 may include a decorative material side 14 (e.g., decor), and a backing material side 16. Embodiments of the headliner 10 may include an edge structure of the molded headliner flange (e.g., end flange of headliner) with long recesses and projections. The sliding sunroof cassette 12, usually an extruded aluminum profile or an injection molded part, is depicted as having a combination of recesses and protrusions in the lower area in order to accommodate the molded headliner 10. By “lifting” the headliner 10, the edge structure 18 of the headliner is brought into the receptacle of the sunroof cassette in such a way that the projections of the headliner 10 are in corresponding recesses of the receptacle. The molded headliner may then “pushed” into a final position in a relatively short sliding movement, as further described below.

In FIG. 1, a projection has a first acute angle or bend (less than 90 degrees) followed by a second right angle or bend. The second right angle or bend is in an “up” position. In FIG. 2 the projection also has a first acute angle or bend and a second right angle or bend. However, the second right angle or bend is a “down” position. In FIG. 3 the projection has a first acute angle or bend followed by a second acute angle or bend. The projections of the headliner 10 may be inserted into a slit-shaped opening in the sunroof cassette 12 as shown so the projections of the headliner 10 lie on the projections of the receptacle after the displacement. This described technique may work like a lock. The gap in the receptacle of the sunroof cassette 12 is designed so that the decorative surface 14 of the headliner 10 is pressed against the upper edge of the receiving profile in the sunroof cassette 12, so that there is always an aesthetic, gap-free transition at this boundary edge. As outlined in FIG. 3, undesired slipping out may also be minimized or eliminated by angled outer areas.

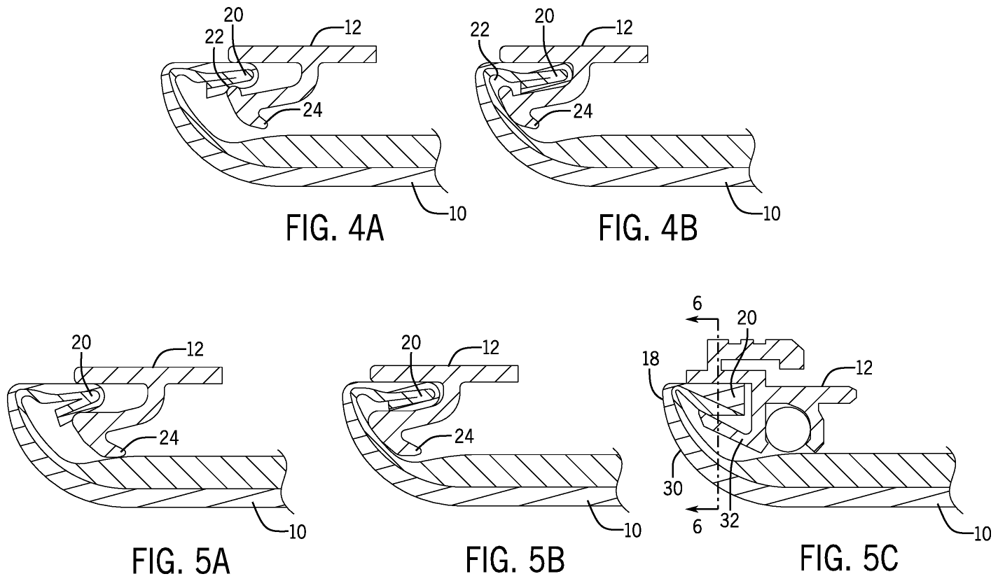

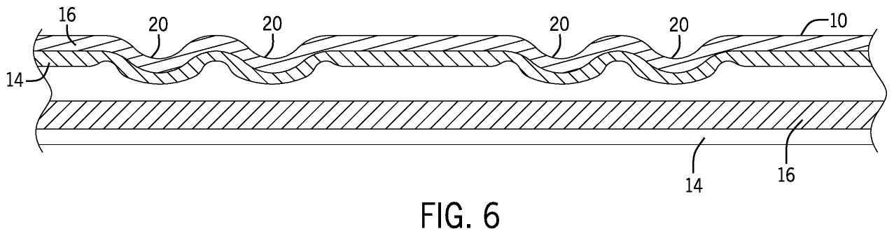

In a more advantageous embodiment, the headliner 10 is designed in the outer region of the vertical flange in such a way that it has one or more predominantly conical impressions 20 within the support areas, for example as shown in FIGS. 4A-B, 5A-C and FIG. 6). These form a positive connection in the inserted position with a corresponding conical receiving groove of the sunroof cassette 12. This conical shape 20 may prevent the edge of the headliner 10 from slipping out unintentionally.

For this purpose, the groove of the sunroof cassette 12 can alternately have recesses for the vertical insertion of the headliner flanges and support surfaces. A preferred embodiment can also have a thinner embossed trim edge in the flat areas of the folded flange, which enables insertion into the narrower slot of the receiving profile, while the predominantly conical shapes 20 of the headliner 10 can be inserted into the larger openings of this receiving profile. The alternating arrangement of the flat and shaped areas of the flange edge (see FIG. 6, which is a view of FIG. 5C) produce a wavy contour and enable the conical shapes 20 of the headliner flange to fit tightly in the conically shaped areas of the receptacle (see FIG. 5C) after the shape of the headliner 10 has been shifted, and both a pressing force of the decor 14 against the upper edge of the receptacle of the sunroof cassette 12 is reached, as well as a pulling out of the headliner 10 flange is prevented from the receiving profile in the direction of the roof opening.

An advantage of this embodiment shown in FIG. 5C, FIG. 6 is a dimensional stability of the sky flanges due to the wavy contours, compared to the up or down angles (see FIG. 1, FIG. 2 for example), which tend to shape changes due to the material tension, especially the decor 14 tension this complicates the threading during assembly. During the locking movement, the insertion of an edge orthogonal to this movement, usually. the front edge of the sunroof opening (the rear edge would also be possible) according to the principle of FIG. 6 or FIGS. 3, 4.

This may result in three of the four edges of the sunroof opening in their intended position after this sliding movement. In the corner areas, it may not be necessary to take measures to accommodate the edge of the headliner. Due to the rigid substrate materials, it may be sufficient to push these areas only under the covering upper contact surface of the cassette 12 or, to simply leave them free, possibly lying on the bottom sight unseen.

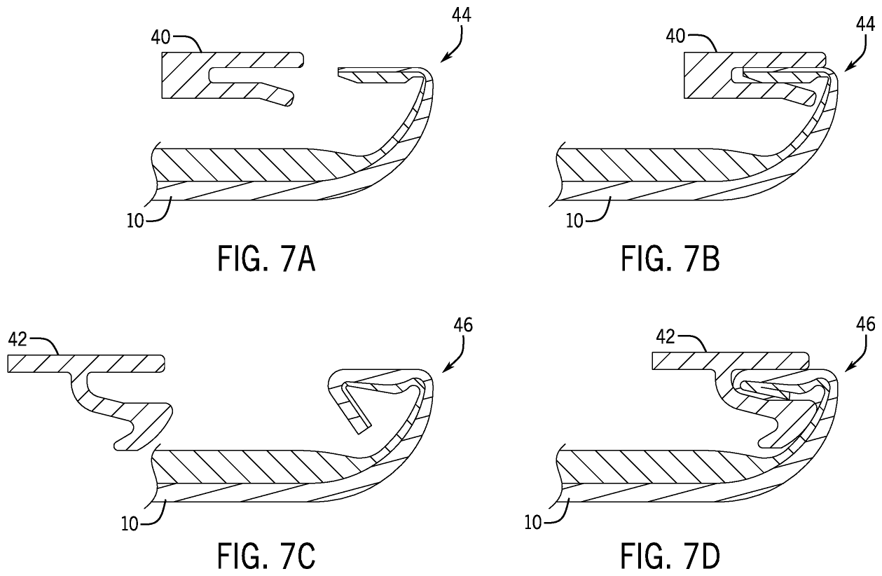

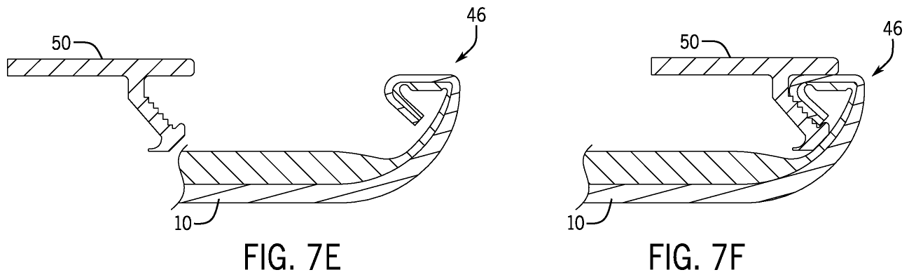

An opposite edge, usually the rear edge, can have the same configuration as in FIG. 6, or also be designed as FIG. 3. The assembly may take place here, however, by using the flexible material properties of the substrate. The edge will be under the mounting profile during installation and will only move into an assembly-ready position after being moved. By gently pulling away from the receptacle to the edge of the headliner 10 with the folded edge termination area (according to FIG. 3) or without the edge termination area folded down (according to FIG. 7B) into the receiving slot or the receiving profile, ribs (FIG. 3) may be inserted.

A further manufacturing process would include a movable bow 40, 42 (see FIGS. 7A-7D), that is to say a movable receiving element 40, 42 which may be guided in the lateral region 44, 46 or bend of the sunroof cassette in the (X-axis) longitudinal direction of the vehicle and is drawn in in the direction of the sunroof cutout. After picking up the edge of the headliner 10 and reaching the end position, this bow 40, 42 can be snapped into the side guide of the cassette. Releasing this locking fixture 40, 42 may enable disassembly in reverse order. An advantage of this process is that there is no interfering edge when sliding mounting.

The designs described herein may save cost and well as weight to a considerable extent and may improve a quality of the transition area to the sunroof cassette 12. The stability of the headliner 10 may be somewhat less due to a lack of a reinforcement frame (also called a sunroof frame). However, this may no longer be relevant after assembly. This may only be taken into account in handling and during installation. However, the resulting stability may meet desired requirements with more careful handling.

Manufacturing Process

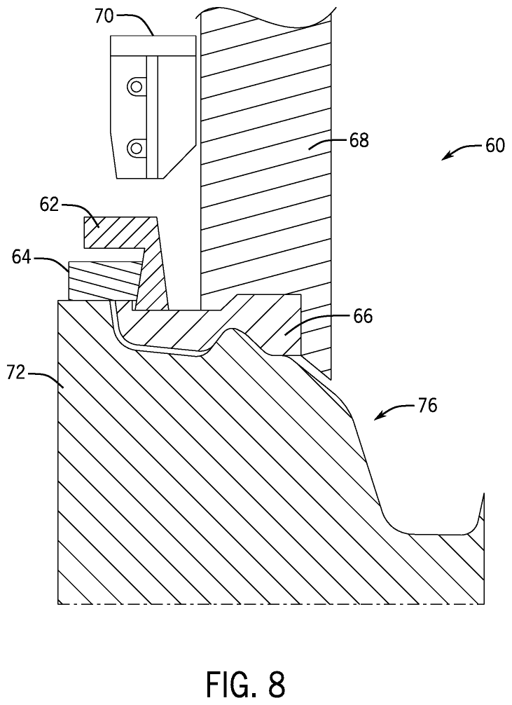

In one embodiment, a folding process on a headliner 10 may take place after the molding process and the trimming of the subsequently molded part in a separate system using special tools shown in FIG. 8. Such contours may not be produced with the dominant substrates based on polyurethane foam and liquid isocyanate in a compression molding process using slides in the molding tool. It may therefore be necessary to produce the desired contour in a subsequent forming process.

Often, a “ripening time” may be used or may be advantageous in these systems in order to obtain an advanced degree of chemical crosslinking in the mold sky substrate. The present description can also be applied to molded parts which are produced in the thermoforming process. These thermoformed carrier systems may be much more suitable folding processes than thermosetting systems.

The structures shown in the edge area (FIGS. 1-5) include more than one change in surface direction outside the raised roof chimney. One of these edges or structures can already be formed without undercuts in the molding process. When the material 14, 16 is bent to create the flange, this already molded structure may be rotated around the edge of the fold and a shape may be created that could not be produced or that may be hard to produce in the molding process. However, it is possible to produce these two deformations in one forming operation if the construction of the heating surfaces and the folding slide are designed for this. Another possibility is a multi-stage folding process, in which the folding edges are produced one after the other.

However, it may be particularly advantageous if the complex shaping is divided into the shaping process and the folding process, the shaping of the embossments or the bevels in the outer region of the later flange preferably taking place during the shaping process and already being present in the subsequent shaping process for producing the flange-like edge.

The surfaces that are to be bent may be usually curved and may be essentially determined by the shape of the outer roof surface of the vehicle. Bending the surface along a curved line would result in a counter-curved surface. Without the elasticity and deformability of the substrate, this may not be possible. In certain embodiments (FIG. 3-6), the flange or the erected edge is divided into partial areas by trimming. This subdivision is advantageous for the folding process, since it has a similar effect to relief cuts on the stretching of the material edge and prevents cracks or block formation.

Fastening the Headliner to the Sunroof Cassette

FIGS. 1 and 2 illustrate a first embodiment of the headliner 10 two bends in the outer region of the flange. The bend(s) may prevent the assembled flange from slipping out of the sunroof frame 12.

The underside of the receptacle of the sunroof cassette 12 may not be closed, but may be divided into many segments of equal length at least on one side of the headliner, as is the edge region of the headliner. If the headliner is shifted by the length of such a segment, the area of the inserted headliner edge may come into a free space in the receptacle and the headliner can be dismantled downwards.

The segments of the headliner 10 and the recesses in the sunroof cassette 12 are preferably 10 mm-80 mm long, particularly preferably up to approximately 40 mm. The shifting of the headliner 10 for locking or unlocking the assembly and disassembly is preferably carried out in or against the direction of travel, since the effect of interfering edges may be greater with a shift from one side of the vehicle to the other. The sliding direction can be in the direction of travel as well as against the direction of travel. This directional definition may depends on the cheaper interfering edge used. Since the headliner may be inserted offset in the X direction, there may usually be an unfavorable overlap with the A-pillars at the front or the rear pillars. The middle pillar, the B-pillar, also may represents disruptive edge. However, the flexibility of the headliner should tolerate these obstacles.

FIG. 3 illustrates, in an embodiment, bends where a defined buckling edge is molded into the edge such that the predominantly horizontal molded headlining edge with a free-standing bend may be pushed against an inclined configuration of the receptacle. The free-standing bends may be pressed against the slope and bent inwards. Thus, a permanent restoring force (e.g., bias force) may be created, which pushes the upper edge of the flange with the decor 14 against the adjacent sunroof cassette 12. This may create a more aesthetic, non-positive transition of these components without the tolerance problems other solutions. Deviations have an impact on the passenger compartment, where they are not perceived visually.

FIG. 4A shows an embodiment similar to FIG. 3, but there is a slot in the sunroof cassette instead of the oblique design. The slot width is dimensioned so that the material doubling, which results from the horizontal molded headliner 10 edge and the folded edge, can just be pushed into the slot of the sunroof cassette. After insertion, the upper edge of the headliner 10 with the decorative layer may be pressed against the lower edge of the opening of the sunroof cassette 12, thus ensuring the desired aesthetic transition. FIG. 4A may be designed without a stop edge 22 and may suitable for dismantling in the same direction.

FIG. 4A includes a stop edge 22 in the cassette 12 for the trim edge of the headliner 10. The trim edge is shown as coming to lay at the end of the fold behind a projection in the receptacle. This prevents the headliner from slipping out of this position. FIG. 4B does not include the stop edge 22. However, both figures include a tail 24 which may be used to abut against material 16. The descriptions in FIGS. 1 and 2 regarding the length of the segments and the subsequent comments on the installation situation also apply to FIGS. 4A, 4B if they were divided into recesses and projections for improved disassembly.

FIGS. 5A-5D shows an advantageous embodiment of the roof liner 10, wherein conically tapered impressions 20 were formed in the molding process, which are located in the flange-like, almost horizontally remaining edge after the folding process. The embossments are in the invisible area after assembly and merge into the predominantly horizontal, partially visible area. After assembly, a positive connection is made with the sunroof cassette to prevent the edge from slipping out.

Another advantage of this design is that the conical contour 20 can be inserted more securely. In contrast, it may be more difficult to thread the relatively thin flat structure of the angled variants described above (FIGS. 1, 2) into the narrower slots of the cassette at the same time.

FIG. 6 shows the structures of FIG. 5C in a side view. The descriptions of FIGS. 1 and 2 regarding the length of the segments and the subsequent comments on the installation also apply to FIG. 5C and FIG. 6.

FIGS. 7A-7D show a technique for the assembly of the last edge to be assembled, the receptacle, in the case shown being a bow-like component 40, 42, which are pushed into edges 44, 46, respectively to accommodate the entire width of the headliner 10 and snaps into a final position. This approach could also be combined in combination with FIG. 3 or FIG. 4. FIGS. 7E and 7F show a cassette 12 structure 50 having ridges terminating in a lower edge. The headliner 10 may include edges 46 or similar bent or formed edges that may be pushed into the structure 50 and retained in place. The ridges and/or edge may prevent the headliner 10 from separating from the cassette 12.

FIG. 8 shows a two-component presser system or machinery 60 that may be used to press or form a fold in the headliner 10. The machinery 60 may include two sliding components 62, 64, which may slide on the X and or Y-axis to form the headliner 10 edges. A guide component 68 may guide a heating element 70 to abut against the components 62, 64, applying heat through the components 62, 64, into the headliner 10. A pressing component 66 may also be used to press against a component 72 having a contour or curvature 76 (e.g., a curvature for the headliner 10). As referred to herein, “flange” may refer to an edge of the headliner 10.

Understandably, the present invention has been described above in terms of one or more preferred embodiments and methods. It is recognized that various alternatives and modifications can be made to these embodiments and methods that are within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention. The present invention, therefore, is intended to be limited only by the scope of the appended claims.

1. A system, comprising:
a headliner, which has a bent shape in an area of a sunroof opening, which comprises a fold, the fold comprising a flange with a shape adjoins the fold, which enables pull-out installation of the headlining without the use of additional fasteners in the area of the sunroof opening.

2. The system of claim 1, wherein the headliner is attached to a sliding roof cassette having at least one roof opening on the body of a vehicle.

3. The system of claim 1, wherein a shape of the flange comprises projections in a horizontal surface, and wherein between these projections recesses of approximately the same length and depth are arranged, which correspond to sunroof projections of the sunroof cassette and further characterized in that by moving the headliner into its intended position, the projections of the headliner abut or interface with the sunroof projections of the sunroof cassette.

4. The system of claim 3, wherein the projections of a predominantly horizontal headliner edge have at their end a change in shape direction, which result in a positive connection with the receptacle of the sunroof cassette.

5. The system of claim 1, wherein the surfaces of the headliner edge comprise shaped structures and further characterized in that by moving the headliner with the shaped structures a positive connection with the receptacle of the sunroof cassette is created and the positive connection minimizes or prevents the flange from being pulled out sideways.

6. The system of claim 1, wherein a predominantly horizontal folding flange has at its outer edge a further crease line that produces an angular bend on the outer edge and that the angular bend is over the entire length of the flange or only in segments, and wherein the headliner with the angular bend rests on an inclined support ramp for receiving the sunroof cassette.

7. A method, comprising:
mounting a headliner with a sliding roof cassette, wherein the sliding roof cassette comprises cassette projections and recesses which are arranged in mirror image to projections of the headliner flange or structures in the headliner flange, characterized in that that the overlapping end position of both components is achieved by moving the headliner by the length of a projection of the projections, wherein the projections of the headliner rest on load-bearing projections of the sliding roof frame.

8. The method of claim 7, wherein the headliner is mounted vertically to the sunroof cassette and further characterized in that the projections of the headliner are lifted vertically into the recesses in the sunroof cassette and by horizontally displacing the headliner, the projections of the roof lining rest on the projections of the sunroof cassette.

9. The method of claim 7, wherein the surfaces of the headliner edge comprise shaped structures and further characterized in that by moving the headliner with the shaped structures a positive connection with the receptacle of the sunroof cassette is created and the positive connection minimizes or prevents the flange from being pulled out sideways wherein the receptacle of the sunroof cassette contains areas with slot openings of different widths, and wherein larger slot opening can accommodate the flanges of the flange and that the positive connection is created in the longitudinal direction by moving the headliner area of the narrower slots.

10. The method of claim 7, wherein the headliner is mounted in the longitudinal direction, characterized in that the projections of the roof lining are brought into spaces of the projections of the sunroof cassette.

11. The method of claim 7, wherein the roof lining is first mounted horizontally on one side in a transverse direction to the sunroof cassette and then ab overlap of the opposite side of the two components is generated by moving the roof lining in the longitudinal direction.

12. The method of claim 7, wherein a predominantly horizontal folding flange has at its outer edge a further crease line that produces an angular bend on the outer edge and that the angular bend is over the entire length of the flange or only in segments, and wherein headliner with the angular bend rests on an inclined support ramp for receiving the sunroof cassette, and wherein during the assembly of the headliner the angular bend is pushed against an obliquely upward counterpart, whereby the top of the folding flange non-positively from below against the upper limit of the receptacle of the sunroof cassette is pressed.

13. The method of claim 12, wherein during the assembly of the headliner the angular fold is completely or partially folded and is received in a slot in the receptacle of the sunroof cassette.

14. The method of claim 12, wherein when installing the headliner the headliner is not moved, but at least one movable element of the sunroof cassette is moved with a receptacle to accommodate the folding flange.

15. The method of claim 13, wherein the folding flange is designed without a bend and the trimming edge of the folding edge is received by at least one movable element of the sunroof cassette by moving this element from a receptacle.

16. A method for manufacturing a headliner comprising:
producing a headliner flange via a folding slide that only moves horizontally and remains in this position until the substrate is dimensionally stable by cooling.

17. The method of claim 16, wherein producing the headliner flange comprises a pressing that remains in its working position until the substrate is dimensionally stable by cooling.

18. The method of claim 17, comprising producing contours in the headliner flange completely or partially in the molding process of the headliner and with a fold of the headliner flange in a final position.

19. The method of claim 17, wherein producing the contours in the headliner flange is not done or not entirely done in the molding process, but entirely or partially done during the folding process.

20. The method of claim 16, comprising producing a material doubling of the headliner flange via the pressing, wherein the presser is in two parts and a first part of the presser is driven separately from the second part, thereby producing the material doubling.
